(19) United States
(12) Patent Application Publication
(10) Pub. No.: US 2002/0149490 A1
(43) Pub. Date: Oct. 17, 2002

(54) Passenger detection system

(76) Inventors: Lonnell Butler, Chicago, IL (US); Darryl Butler, Chicago, IL (US)

Correspondence Address: Matthew J. Peirce, Esq., 1550 Starlight Canyon Avenue, Las Vegas, NV, 89123, US

(21) Appl. No.: 09/833,586

(22) Filed: Apr. 13, 2001

(51) Int. Cl. G08B 21/00

(52) U.S. Cl. 340/667; 340/666; 340/425.5; 340/438; 701/45; 701/49

(57) ABSTRACT

A passenger seat detection system for vehicles is disclosed. The detection system will alert the driver of a bus if people or objects are still remaining on a seat within that particular vehicle. Each seat will contain an incorporated sensor which will detect the weight of an object or person sitting on that seat. The sensor is electronically connected to an internal electronic system that connects up to a dashboard light and horn, alerting a driver to the presence of someone or something remaining on the vehicle. The passenger seat detection system could be used on all types of buses and other means of transportation, such as trains, airplanes, or other common carrier or public means of transportation.

### I. BACKGROUND OF THE INVENTION

The present invention concerns that of a new and improved passenger and object detection system for use on vehicles.

### II. DESCRIPTION OF THE PRIOR ART

U.S. Pat. No. 5,602,425, issued to Wilhelmi et al., discloses a seat-occupancy-detection device in a motor vehicle, by means of which seat functions can be actuated dependent on the load acting on the seat.

U.S. Pat. No. 5,404,128, issued to Ogino et al., discloses a safety control apparatus which positively discriminates between an object and a person through the detection of subtle physical movement.

U.S. Pat. No. 5,128, 651, issued to Heckart, discloses an alarm system for vehicles such as school buses which forces the driver to walk through the vehicle to silence the alarm at the end of each route so that he will detect the presence of passengers remaining on board.

U.S. Pat. No. 3,749,866, issued to Tiazkun et al., discloses a planar, low profile switch assembly at each occupant position of a foam vehicle seat construction which comprises upper and lower spaced, flexible conductive metal strips with a foam strip interposed between and separating the metal strips.

### III. SUMMARY OF THE INVENTION

The present invention is that of a passenger seat detection system for vehicles. The detection system will alert the driver of a vehicle if people or objects are still remaining on a seat within that particular vehicle. Each seat contains an incorporated sensor which will be triggered by the weight of an object or person sitting on that seat. The sensor is electronically connected to an internal electronic system that connects up to an console on the sensor of the bus and lights a signal bulb alerting the driver to the presence of someone or something remaining on the vehicle.

When installed on a bus, the present invention would ensure that not a single child would be left on the school bus, and would also ensure that any objects left behind by children would be promptly discovered by an attentive bus driver. The present invention could be used on all types of buses and other means of transportation, such as trains, airplanes, or other common carrier or public means of transportation. By accomplishing these goals, the present invention will help to prevent lawsuits and will prevent mass transit drivers and other employees from being dismissed for not being attentive enough.

There has thus been outlined, rather broadly, the more important features of a passenger and object detection system in order that the detailed description thereof that follows may be better understood and in order that the present contribution to the art may be better appreciated. There are, of course, additional features of the passenger and object detection system that will be described hereinafter and which will form the subject matter of the claims appended hereto.

In this respect, before explaining at least one embodiment of the passenger and object detection system in detail, it is to be understood that the passenger and object detection system is not limited in its application to the details of construction and to the arrangements of the components set forth in the following description or illustrated in the drawings. The passenger and object detection system is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present passenger and object detection system. It is important, therefore, that the claims be regard as including such equivalent constructions insofar as they do not depart from the spirit and scope of the present invention.

It is therefore an object of the present invention to provide a passenger and object detection system which has all of the advantages of the prior art and none of the disadvantages.

It is another object of the present invention to provide a passenger and object detection system which may be easily and efficiently manufactured and marketed.

It is another object of the present invention to provide a passenger and object detection system which is of durable and reliable construction.

It is yet another object of the present invention to provide a passenger and object detection system which is economically affordable and available for relevant purchasing government entities.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a perspective side view of a portion of the present invention embedded in a typical bus seat.

FIG. 2 shows a top schematic view of the present invention and accompanying internal electronic schematic system.

FIG. 3 shows a front view of a dashboard panel of a bus that includes portions of the present invention.

### V. DESCRIPTION OF THE PREFERRED EMBODIMENT

Referring now to FIG. 1, seat 2 is shown being supported by legs 4, 6, 8, and 10. Seat 2 would be a soft cushion-type seat that would contour itself to the weight of an object or person on top of seat 2. Two or three individual seats may be combined into an individual platform to allow for economy in seating if a plurality of seats 2 were installed in public transportation.

FIG. 1 also shows upper metal plate 12 and lower metal plate 14, which are located within seat 2. Upper metal plate 12 and lower metal plate 14 are thin metal strips which are located horizontally within seat 2. Upper metal plate 12 and lower metal plate 14 run in parallel planes and do not touch each other when an object or person is not resting on seat 2. First low voltage wire 16 connects with upper metal plate 12, while second low voltage wire 18 connects with lower metal plate 14. Both first low voltage wire 16 and second low voltage wire 18 of each seat 2 connect with seat sensor 28 and horn 32, which are located on dashboard 33 in front of driver's seat 30. All other seats on a vehicle would have the same configuration as that shown in FIG. 1.

When a person or object is on seat 2, upper metal plate 12 will be forced onto lower metal plate 14, therefore closing the electrical circuit between first low voltage wire 16 and second low voltage wire 18. When this occurs, sensor 28 and horn 32 would be activated, alerting a driver that a person or object still remains on the bus. Because of its obtrusive nature, horn 32 would preferably have a deactivating mechanism which would allow a driver to turn off horn 32 after it has begun to emit sound. Sensor 28 would preferably be a light, and would preferably not have a deactivating mechanism, because sensor 28 would not be nearly as obtrusive as horn 32 would be. Horn 32 would be designed to emit either a series of intermittent sounds or a continuous sound

In an alternative embodiment of the present invention, sensor 28 could instead be a dash-mounted light console with a plurality of lights, with each light being associated with the electronics of a particular seat.

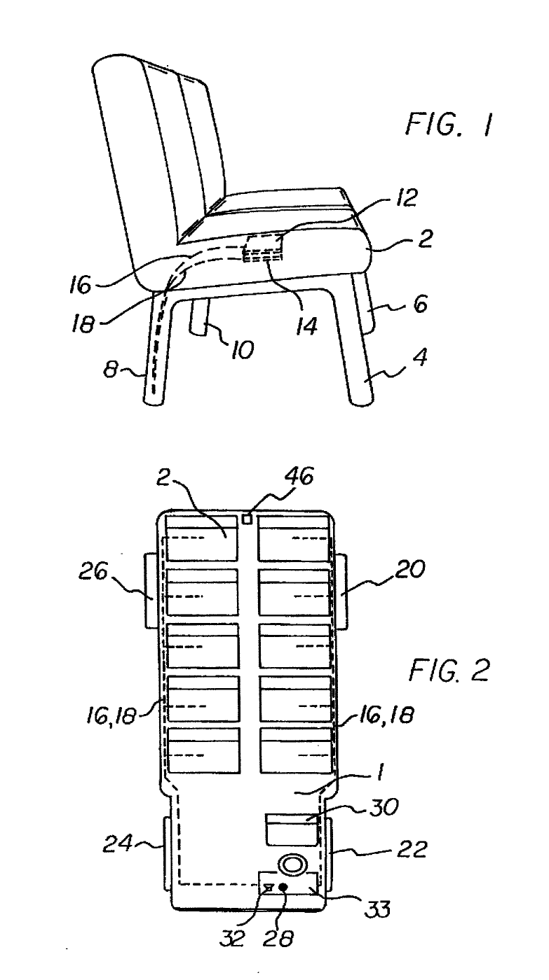

FIG. 2 shows a top schematic view of bus 1 that includes the present invention, along with wheel wells 20, 22, 24, and 26, which cover the tires of the bus. Bus 1 includes a plurality of seats 2, all of which have the same configuration as seat 2 shown in FIG. 1. First low voltage wire 16 and second low voltage wire 18, shown exiting each seat, travel alongside the inner wall of each side of bus 1. First low voltage wire 16 eventually connects up to a power source, while second low voltage wire 18 eventually connects to sensor 28 and horn 32. Driver's seat 30 is also shown for perspective. Each first low voltage wire 16 and second low voltage wire 18 from each seat 2 acts as its own circuit and is not electronically connected with any other first low voltage wire 16 or second low voltage wire 18 from any other seat.

The representation of the present invention in bus 1 is not meant to be limiting. The present invention could be used in a wide variety of forms of public transportation such as trains, airplanes, or other common carrier or public means of transportation. Bus 1 is just used to illustrate one possible use of the present invention.

Box 46 is shown mounted to the rear of bus 1, and box 46 contains a shut-off switch for horn 32. A bus driver must get up and walk the entire length of the bus to manually open box 46 and flip the shut-off switch located within box 46 to turn off the horn. The shut-off switch within box 46 would be electronically connected to the horn 32 and would deactivate any sound emitting from horn 32. The horn 32 would stay deactivated until activated again by another sensor located in a seat 2.

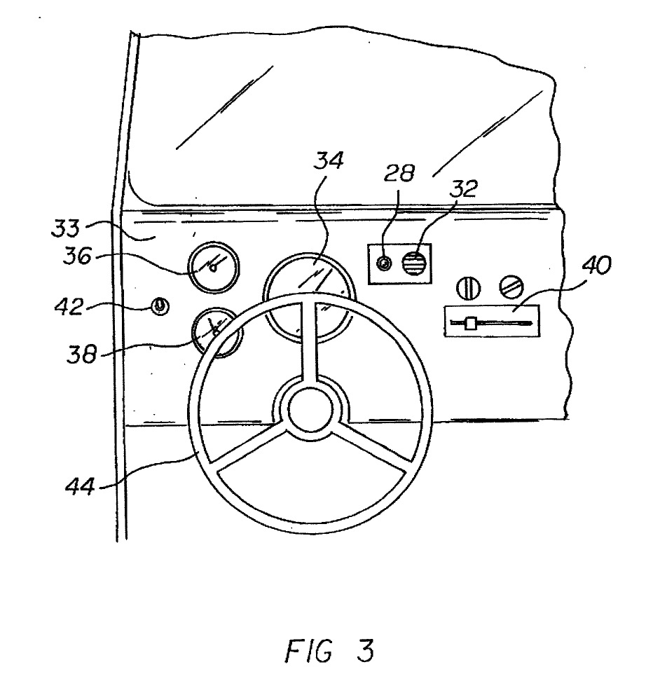

FIG. 3 shows a front view of dashboard 33 of bus 1. Shown are standard components such as speedometer 34, fuel gauge 36, engine heat indicator 38, air conditioner switch 40, dummy lights 42, and steering wheel 44. In addition, sensor seat 28 and horn 32 are shown.

Dashboard 33 shown in FIG. 3 is not meant to be limiting or restrictive, as other standard dashboard components may be present or in different locations, but is meant to show one of many possible configurations of dashboard 33 that would be located on a vehicle.

What I claim as my invention is:

1. A passenger detection system comprising
(a) a vehicle, the vehicle including a dashboard,
(b) at least one sensor activation light located on the dashboard,
(c) a plurality of seats located within the vehicle, each seat including a support structure to fixedly attach the seat to a floor surface within the vehicle, each seat including a cushion-type platform, and
(d) a plurality of sensors, each sensor comprising a first metal plate, each sensor further comprising a second metal plate, the second metal plate being placed immediately adjacent to the first metal plate, the second metal plate being placed perpendicular to the first metal plate, each sensor further comprising a first wire having two ends, a first end and a second end, the first end of the first wire connected to a power source, the second end of the first wire connected to the first metal plate, each sensor further comprising a second wire having two ends, a first end and a second end, the first end of the second wire connected to at least one sensor activation light on the dashboard of the vehicle, the second end of the second wire connected to the second metal plate, each sensor being located within a cushion-type platform of a seat, and
(e) means for activating the sensor activation lights on the dashboard.

2. A passenger detection system according to claim 1, wherein the means for activating the sensor activation lights on the dashboard further comprises:
(a) an amount of weight placed on a cushion-type platform of a seat above the location of a sensor located within the seat,
(b) an amount of power originating from the power source and passing onward through the first wire to the first metal plate,
(c) wherein the first metal plate touches the second metal plate, causing power from the power source to travel through the first metal plate to the second metal plate on to the second wire, allowing the power to travel to the sensor activation light on the dashboard, causing the sensor activation light on the dashboard to light up.

3. A passenger detection system according to claim 1 which further comprises a horn, the horn being located on the dashboard, the horn being connected to the second end of the second wire, wherein the horn would commence to emit sound when the horn would receive power input from the second wire.

4. A passenger detection system according to claim 3 which further comprises a shut-off switch, the shut-off switch mounted within the vehicle near the rear portion of the vehicle, the shut-off switch being electronically connected to the horn in such a manner that if a user activates the shut-off switch, the horn will cease emitting sound.

5. A passenger detection system according to claim 3 wherein the horn would emit an intermittent series of sounds when activated upon receiving power input from the second wire.

6. A passenger detection system according to claim 3 wherein the horn would emit a continuous sound when activated upon receiving power input from the second wire.
